(19) United States
(12) Patent Application Publication
(10) Pub. No.: US 2020/0064262 A1
(43) Pub. Date: Feb. 27, 2020

(54) OPTICAL MEMBER, LIGHT MEASURING DEVICE, SAMPLE HOLDING MEMBER, LIGHT MEASURING SYSTEM AND SPECIFIC WAVELENGTH LIGHT GATHERING MEMBER

(71) Applicants: Kyushu University, National University Corporation, Fukuoka (JP); Ushio Denki Kabushiki Kaisha, Tokyo (JP)

(72) Inventors: Yuji OKI, Fukuoka-shi (JP); Kinichi MORITA, Tokyo (JP); Hiroyuki OHASHI, Tokyo (JP)

(73) Assignees: Kyushu University, National University Corporation, Fukuoka (JP); Ushio Denki Kabushiki Kaisha, Tokyo (JP)

(21) Appl. No.: 16/466,115

(22) PCT Filed: Nov. 30, 2017
(86) PCT No.: PCT/JP2017/043209

§ 371 Date: Jun. 3, 2019

(30) Foreign Application Priority Data
Dec. 6, 2016 (JP) 2016-237041
Aug. 30, 2017 (JP) 2017-166116

(51) Int. Cl. G01N 21/64; G02B 19/00; G02B 1/04

(52) U.S. Cl. CPC G01N 21/64; G01N 2201/0638; G02B 1/041; G02B 19/0009

(57) ABSTRACT

A first aspect of the present invention is an optical member that blocks straight traveling of light of a second wavelength rather than straight traveling of light of a first wavelength, and is provided with a silicone resin part, and optical material particles dispersed in the silicone resin part, wherein the refractive indexes of the silicone resin part and the optical material particles match at the first wavelength, and do not match at the second wavelength. Consequently, it becomes possible to provide an optical member or the like that selectively transmit a specific wavelength (the first wavelength) by a member different from those of conventional optical elements.

### TECHNICAL FIELD

The present invention relates to an optical member, a light measuring device, a sample holding member, a light measuring system, and a specific wavelength light gathering member. More particularly, the present invention relates to an optical member and the like that interrupts straight traveling of light having a second wavelength rather than straight traveling of light having a first wavelength.

### BACKGROUND ART

In recent years, downsizing and measurability with higher performance have been more and more demanded for a light measuring device using a photometric analysis technique such as an optical density method, or a laser-induced fluorescence method or the like. This kind of light measuring device has been employed for a broad range of bioanalysis in the life science technical field and is expected to be usable for a measuring device for, for example, a point-of-care testing (POCT). When being used as the measuring device for the POCT, the above mentioned light measuring device is required to be downsized to the extent to be portable for a user.

When downsizing the light measuring device, however, the distance gets inevitably closer between a light source for irradiating a sample with measurement light and a detector for monitoring observed light from the irradiated sample. Also, various optical elements lie on a light guiding path constituting a measuring optical system, which guides measurement light from the light source to the sample, and on another light guiding path constituting an observed light condensing optical system, which guides the observed light from the sample to the detector.

For this reason, as the light measuring device is getting downsized, the stray light, which may be a noise in the measurement, considerably affects, such as reflected light and scattering light generated when the light travels (advances) on those light guiding paths. In order to suppress the stray light from affecting as far as possible and downsize the light measuring device, the inventors of the present invention have proposed a certain light measuring device in which the light guiding paths are configured with silicone resin.

The light guiding path in the above mentioned light measuring device is, at least partially, filled with transparent resin for guiding the measurement light from the light source and the observed light from the sample. Further, the light guiding path made of the transparent resin is enclosed (surrounded) by resin in which a pigment (colorant) having a property absorbing the above mentioned stray light is dispersed therein.

In this light guiding path, with employing the same material for both of the transparent resin constituting the light guiding path and the pigment-containing resin, it is possible to suppress light from reflecting or scattering at an interface (boundary plane) at which both resin contact each other.

In addition, as the stray light entering into the pigment-containing resin is absorbed by the pigment, the entered stray light hardly returns to the transparent resin constituting the light guiding path. Also, the stray light hardly leaks outside from the pigment-containing resin.

As a result, it mostly suppresses the stray light, which is generated by complex multiple reflections of the stray light, from affecting so that the optical system on the light guiding path are not required to accommodate such complex multiple reflections.

Optical elements such as a lens, an optical filter, or a prism or the like is buried in the light guiding path made of transparent silicone resin as appropriate in order for forming the light to be guided and the wavelength filtering.

For example, a certain light measuring device disclosed in the Patent Literature 1 is a light (in particular laser) induced fluorescent measuring device. The light measuring device of the Patent Literature 1 employs a light guiding path made of the above mentioned transparent silicone resin for a fluorescent light condensing optical system which guides fluorescent light emitted from a sample, which is irradiated with excitation light from a laser light source, to a sensor. Then, a plurality of lenses and a plurality of optical filters are buried in the light guiding path.

The plurality of optical filters use, for example, notch filter, which reflects light having a wavelength of the above mentioned excitation light, and a colored glass filter, which absorbs light other than fluorescent light emitted from the sample.

However, such notch filter and colored glass filter are in general expensive. For this reason, the inventions of the present invention have been proposed a certain optical element that bears comparison with such notch filter or the colored glass filter in terms of performance while being inexpensive, and has a high degrees of freedom in shape.

For example, the inventors of the present invention have proposed, in the Patent Literature 2, a certain structure, in a hollow (cavity) arranged in the transparent silicone resin, in which a diffraction grating shaped plane formed by resin is arranged at one of boundary planes between the hollow and the resin, and the light guiding path is bent at both of the front and the rear of the diffraction grating shaped plane. Light incident to the diffraction grating shaped plane is diffracted, and only light advancing along the bent light path arrives at the measuring portion.

As a result, such structure disclosed in the Patent Literature 2 is assumed to have an optical property having an equivalent performance to the expensive notch filter.

### LISTING OF REFERENCES

### Patent Literature

PATENT LITERATURE 1: Japanese Patent Publication No. 5665811 B
PATENT LITERATURE 2: Laid-open Publication of Japanese Patent Application No. 2016-109564 A
PATENT LITERATURE 3: Japanese Patent Publication No. 4982386 B

### SUMMARY OF THE INVENTION

### Problems to be Solved by the Invention

However, both in the above mentioned light guiding path disclosed in the Patent Literature 1 and the structure disclosed in the Patent Literature 2 having the diffraction grating shaped plane, an arrangement of respective components is critical. Accordingly, it entails more restriction in structure so as to render the degree of freedom in shape lower.

Taking the above mentioned circumstances into consideration, the present invention has been made in order to solve the above mentioned problems and an object thereof is to provide an optical member that is capable of being alternative to the conventional notch filter, which is expensive, or the like and also having a higher degree of freedom in shape.

### Solution to Problems

In order to solve the above mentioned problems, according to a first aspect of an optical member of the present invention, there is provided an optical member that interrupts straight traveling of light having a second wavelength rather than straight traveling of light having a first wavelength. The optical member comprises: a silicone resin portion and optical material particles dispersed in the silicone resin portion. The refractive index of the silicone resin portion and the refractive index of the optical material particles coincide with each other at the first wavelength and do not coincide with each other at the second wavelength.

Furthermore, according to a second aspect of the optical member of the present invention, in the above described first aspect of the optical member, the silicone resin portion may be made of polydimethylsiloxane (PDMS) and the optical material particles may be made of silicon dioxide (SiO₂).

Yet furthermore, according to a third aspect of the optical member of the present invention, in the above described second aspect of the optical member, the optical material particles may have a short diameter (minor axis) equal to or greater than 0.1 μm and equal to or less than 20 μm, the optical material particles dispersed in the silicone resin portion may have density equal to or greater than 10 wt % and equal to or less than 20 wt %, and the optical material particles may have a light path length equal to or greater than 0.2 mm and equal to or less than 10 mm.

Yet furthermore, according to a fourth aspect of the present invention, in the above described first aspect of the optical member, the silicone resin portion may be made of polydimethylsiloxane (PDMS) and the optical material particles may be made of calcium fluoride (CaF₂).

Yet furthermore, according to a fifth aspect of the present invention, in the above described fourth aspect of the optical member, the optical material particles may have a short diameter (minor axis) equal to or greater than 20 μm and equal to or less than 500 μm, the optical material particles dispersed in the silicone resin portion may have density equal to or greater than 5 wt % and equal to or less than 50 wt %, and the optical material particles may have a light path length equal to or greater than 0.2 mm and equal to or less than 10 mm.

Yet furthermore, according to a sixth aspect of the present invention, there is provided a light measuring device comprising: a filtering light guiding path that includes any one of above described first to fifth aspects of the optical member as at least a part of the light guiding path; and a pigment-containing resin portion that contacts the filtering light guiding path.

Yet furthermore, according to a seventh aspect of the present invention, there is provided a sample holding member for holding a sample for light measurement, comprising any one of above described first to fifth aspects of the optical member in at least a part of a light transmissive (permeable) portion that transmits light from a light source portion.

Yet furthermore, according to an eighth aspect of the present invention, in the above described seventh embodiment of the sample holding member, the sample holding member may be entirely made of the optical member.

Yet furthermore, according to a ninth aspect of the present invention, in the above described seventh or eighth aspect of the sample holding member, the optical member may comprise: a first particle containing resin portion having first particles as the optical material particles; and a second particle containing resin portion having second particles different from the first particles as the optical material particles, refractive index of the silicone resin portion and refractive index the first particles may coincide with each other at the first wavelength and may not coincide with each other at the second wavelength different from the first wavelength, and refractive index of the silicone resin portion and refractive index of the second particles may coincide with each other at a third wavelength different from the first wavelength and may not coincide with each other at a fourth wavelength different from the third wavelength.

Yet furthermore, according to a tenth aspect of the present invention, in the above described seventh or eighth aspect of the sample holding member, the optical member may comprise: a first particle containing resin portion having a first silicone resin portion as the silicone resin portion; and a second particle containing resin portion having a second silicone resin portion different from the first silicone resin portion as the silicone resin portion, refractive index of the first silicone resin portion and refractive index of the optical material particles may coincide with each other at the first wavelength and may not coincide with each other at the second wavelength different from the first wavelength, and refractive index of the second silicone resin portion and refractive index of the optical material particles may coincide with each other at a third wavelength different from the first wavelength and may not coincide with each other at a fourth wavelength different from the third wavelength.

Yet furthermore, according to an eleventh aspect of the present invention, there is provided a light measurement system comprising a sample holding member for holding a sample and a light measuring device. The light measuring device comprises: a light source portion that irradiates the sample with light; a light condensing lens portion that condenses light from the sample; and a light measuring portion that measures the light condensed by the light condensing lens portion. The sample holding member is the sample holding member according to any one of seventh to tenth aspects of the sample holding member.

Yet furthermore, according to a twelfth aspect of the present invention, in the above described eleventh aspect of the light measurement system, the sample holding member may comprise: a first transmissive portion made of a first particle containing resin portion having first particles as the optical material particles; and a second transmissive portion made of a second particle containing resin portion having second particles different from the first particles as the optical material particles. The light measuring device may comprise: a first light source portion that irradiates the sample with first light; a second light source portion that irradiates the sample with second light; a first light condensing lens portion that condenses light from the sample, which is transmitted through the first transmissive portion; a second light condensing lens portion that condenses light from the sample, which is transmitted through the second transmissive portion; a first light measuring portion that measures light condensed by the first light condensing portion; and a second light measuring portion that measures light condensed by the second light condensing portion.

Yet furthermore, according to a thirteenth aspect of the present invention, in the above described twelfth aspect of the light measurement system, the first light source portion and the second light source portion may be positioned such that the first light source portion and the second light source portion irradiate opposing faces of the sample holding member with light, respectively, a part of the sample holding member that transmits the first light may be made of the first particle containing resin portion, and a part of the sample holding member that transmits the second light may be made of the second particle containing resin portion.

Yet furthermore, according to a fourteenth aspect of the present invention, there is provided a light measurement system comprising a sample holding member for holding a sample and a light measuring device. The light measuring device comprises: a light source portion that irradiates the sample with light; a light measuring portion that measures light from the sample; a transparent resin portion that fills between a light transmissive portion of the sample holding member and a light receiving face of the light measuring portion; and a pigment-containing resin that encloses the transparent resin portion. The sample holding member is the sample holding member according to any one of seventh to tenth aspects of the sample holding member.

Yet furthermore, according to a fifteenth aspect of the present invention, there is provided a specific wavelength light condensing (gathering) member for condensing light having a first wavelength from a sample, comprising: a lens portion that condenses light from the sample; and an optical member according to any one of first to fifth aspects of the optical member, and the optical member is adjacent to the lens portion.

Yet furthermore, according to a sixteenth aspect of the present invention, in the above described fifteenth aspect of the specific wavelength light condensing member, the specific wavelength light condensing member may further comprise plano-convex lenses in at least an upstream and a downstream of a light path of the optical member.

Yet furthermore, according to a seventeenth aspect of the present invention, in the above described fifteenth aspect of the specific wavelength light condensing member, the specific wavelength light condensing member may be provided with at least one plano-convex lens as the lens portion, and may further comprise a light reflective portion that reflects light, both of incident light to the light reflection portion from the sample and reflective light thereof are transmitted through both of the plano-convex lens and the optical member.

Yet furthermore, according to an eighteenth aspect of the present invention, there is provided a light measuring device for measuring light having a first wavelength from a sample, comprising: a light source portion that irradiates the sample with the light; a specific wavelength light condensing member that condenses light having a first wavelength from the sample; and a light measuring portion that measures light condensed by the specific wavelength light condensing member. The specific wavelength light condensing member is the specific wavelength light condensing member according to any one of fifteenth to seventeenth aspects of the specific wavelength light condensing member.

Yet furthermore, according to a nineteenth aspect of the present invention, in the above described eighteenth aspect of the light measuring device, the light measuring device may further comprise an aperture member at a light incident side of the light measuring portion.

### Advantageous Effect of the Invention

According to various aspects of the present invention, it makes it possible to provide an optical member or the like that selectively transmits light having a specific wavelength (first wavelength) by a member different from conventional optical elements.

Also, the optical member according to the present invention has a simplified structure in which optical material particles are dispersed in a silicone resin and thus has less restriction in structure. In other words, it is sufficient for the optical member to have the silicone resin in which the optical material particles are discretely dispersed. Thus, it can eliminate precise work including adjustment or the like of positions and angles of respective components.

As a result, the optical member according to the present invention has a higher degree of freedom in shape. In addition, it makes it possible to manufacture the optical member with lower cost as the optical member according to the present invention requires less manufacturing processes with higher precision as compared to the conventional optical elements.

Yet in addition, it makes it possible to form the optical member into shapes using a printing technique such as the 3D printing or the like using the silicone resin in which the optical material particles are dispersed as a raw material.

According to the second aspect of the present invention, it makes it possible to provide an optical member that selectively transmits light having a wavelength of 280 nm.

According to the third aspect of the present invention, it makes it possible to selectively transmit light having the wavelength of 280 nm with higher precision.

According to the fourth aspect of the present invention, it makes it possible to provide an optical member that selectively transmits light having a wavelength of 280 nm or 260 nm.

According to the fifth aspect of the present invention, it makes it possible to selectively transmit light having the wavelength of 280 nm with higher precision.

According to the sixth aspect of the present invention, it makes it possible to provide a light measuring device including a filtering light guiding path that selectively transmits light with a specific wavelength (first wavelength).

In addition, it makes it possible to absorb light having a second wavelength, which is interrupted (blocked) from traveling straight by the filtering light guiding path, by a pigment-containing resin portion that contacts the filtering light guiding path so as to suppress stray light from occurring. In other words, the light having the second wavelength incident to the pigment-containing resin portion hardly returns back to the filtering light guiding path and also hardly leaks outside as the stray light from the pigment-containing resin portion, as the light having the second wavelength is absorbed by a pigment.

According to the seventh to eleventh aspects of the present invention, it makes it possible for the sample holding member not only to simply hold the sample but also to selectively transmit light having a specific wavelength (first wavelength). For this reason, it makes it possible to reduce the number of optical elements constituting the light measuring device as compared to the conventional device using an optical element such as the notch filter or the like. As a result, it is capable of facilitating the handling during on site measurement of the POCT.

Furthermore, the optical member according to the present invention has a function to allow light having the first wavelength to travel straight while scattering light having the second wavelength even when the angle of incidence of the light into the optical member is not zero.

On the contrary, the notch filter, which has been conventionally used for wavelength selection, cannot exert the wavelength selectivity function unless the angle of incidence of light is zero. As a result, according to the light measurement system of the present invention, it makes it possible to achieve a structure with a reduced number of optical elements by eliminating a lens for making the angle of incidence of light be zero.

According to the eighth aspect of the present invention, it makes it possible to further downsizing the sample holding member.

According to the ninth, tenth and twelfth aspects of the present invention, it makes it possible to selectively transmit a plurality of rays of light to be simultaneously measured. In addition, it makes it possible to facilitate provision of a member that hardly breaks down during on site measurement, as such member does not require an active element such as a change-over switch or the like.

According to the thirteenth aspect of the present invention, two measuring portions are arranged such that the two measuring portions measure light from opposite directions, respectively. For this reason, it makes it possible to reduce the noise light incident to the respective light measuring portions from non-corresponding light source. In addition, it makes it possible to further downsizing the light measuring device that is capable of simultaneously measuring two rays of light having two wavelengths.

According to the fourteenth aspect of the present invention, it makes it possible to reduce the noise light incident to the light measuring portion, as light scattered by the optical member is absorbed by the pigment-containing resin portion. As a result, it makes it possible to further downsizing the light measuring device as the light measuring device is capable of sufficiently measuring the measurement light without a light condensing lens for condensing the measurement light being provided.

According to the fifteenth to eighteenth aspects of the present invention, it makes it possible to provide an optical member with higher spectroscopic performance. As a result, it makes it possible to shorten the light path length of the light measuring device. In addition, it makes it possible to suppress the light intensity from attenuating on a light receiving face of the light measuring portion.

According to the seventeenth aspect of the present invention, it makes it possible to provide further downsized light measuring device, as the light path thereof is folded. In addition, it makes it possible to make the thickness of the optical member thinner.

According to the nineteenth aspect of the present invention, it makes it possible to provide a light measuring device that is capable of observing sharper peaks with higher precision.

### BRIEF DESCRIPTION OF DRAWINGS

FIG. 1 is a schematic view showing the wavelength dependency of the refractive indexes of the silicone resin and the optical material, respectively.

FIG. 2 is a schematic view showing an exemplary optical member 1 according to the present invention.

FIG. 3 is a view showing the wavelength dependency of the refractive indexes of the PDMS, SiO₂, and CaF₂, respectively.

FIG. 4 is a view showing the transmissivity property of an optical member obtained by dispersing SiO₂ particles in PDMS.

FIG. 5 is a view showing the transmissivity property of another optical member obtained by dispersing CaF₂ particles in PDMS.

FIG. 6 is a schematic view showing an exemplary filtering light guiding path according to the present invention in which a pigment-containing resin portion is provided there around.

FIG. 7 is a schematic view showing an exemplary light measurement system according to the present invention (Embodiment 2).

FIG. 8 is a schematic view showing an exemplary light measurement system according to the present invention (Embodiment 3).

FIG. 9 is a schematic view showing an exemplary light measurement system according to the present invention (Embodiment 4).

FIG. 10 is a schematic view showing an exemplary light measurement system according to the present invention (Embodiment 5).

FIG. 11 is a schematic view showing an exemplary light measurement system according to the present invention (Embodiment 6).

FIG. 12 is a schematic view showing an exemplary light measurement system according to the present invention (Embodiment 7).

FIG. 13 is a view showing the spectroscopic property of a selection filter according to the present invention.

FIG. 14 is a schematic view showing an exemplary light measurement system according to the present invention (Embodiment 8).

FIG. 15 is a schematic view showing an exemplary light measurement system according to the present invention (Embodiment 9).

### DESCRIPTION OF EMBODIMENTS

Hereinafter, embodiments of the present invention will be described with reference to the accompanying drawings in detail. An embodiment 1 is an embodiment directed to an optical member according to the present invention, and embodiments 2 to 7 are embodiments directed to light measurement systems employing the optical member according to the present invention, respectively. It should be noted that embodiments of the present invention are not limited those described in the following exemplary embodiments.

### Embodiment 1

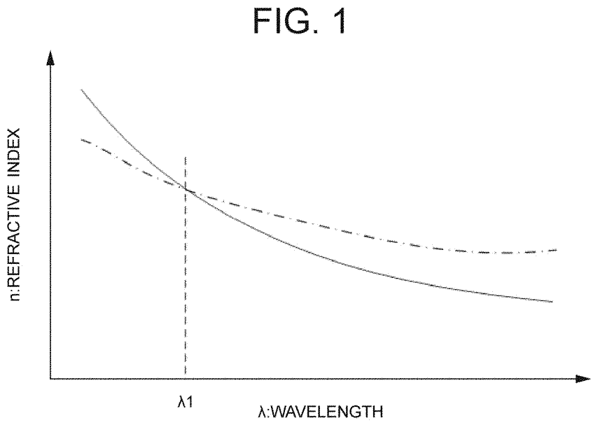

FIG. 1 is a schematic view illustrating the wavelength dependency of the refractive indexes of a silicone resin and an optical material, respectively. A solid line denotes the silicone resin and a dashed-dotted line denotes the optical material. Two curves intersect each other at one point. Hereinafter, it is assumed that λ1 (exemplarily referred to as “first wavelength” recited in the claims) to be a wavelength at which refractive indexes of the silicone resin and the optical material coincide with each other.

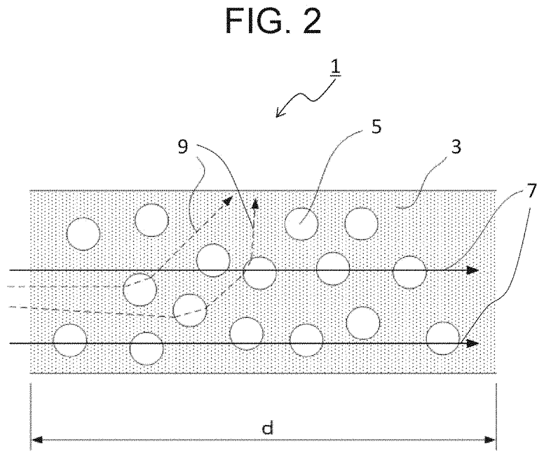

FIG. 2 is a schematic view illustrating an exemplary optical member 1 according to the present invention. In the optical member 1, particles 5 made of the optical material are dispersed in a transparent silicone resin 3.

When respective refractive indexes of two materials contacting each other coincide, an interface (boundary plane) of the two materials can be assumed not to be present optically. For this reason, light having a wavelength λ1, at which the refractive index of the silicone resin 3 coincides with the refractive index of the particles 5, neither reflects, scatters, nor refracts at the interface between the silicone resin 3 and the particles 5. In other words, light 7 having the wavelength λ1, which is incident to the optical member 1 as straight traveling light, travels (advances) straight in the optical member 1.

On the other hand, when irradiate the optical member 1 with light 9 having the wavelength λ2 (exemplarily referred to as “second wavelength” recited in the claims), which does not coincide with the wavelength λ1, the light 9 having the wavelength λ2 reflects, scatters, or refracts at the interface between the silicone resin 3 and the particles 5. For this reason, even when the light 9 having the wavelength λ2 is incident to the optical member 1 as the straight traveling light, the light 9 having the wavelength λ2 does not travel straight in the optical member 1, as the light reflects, scatters, or refracts at the interface between the silicone resin 3 and the particles 5.

In other words, the optical member 1 shown in FIG. 2 may serve as being alternative to, for example, the notch filter, as the optical member 1 functions as an optical filter that selectively transmits the light 7 having the wavelength λ1.

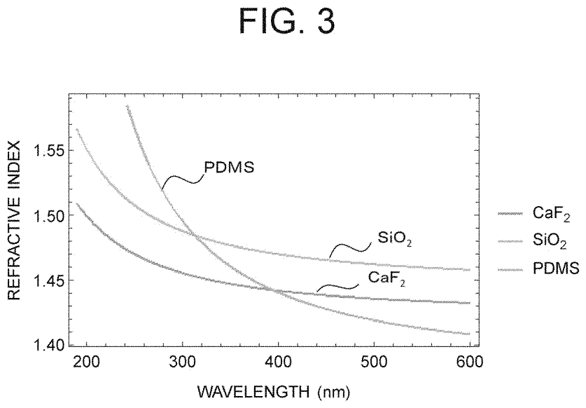

FIG. 3 is a view illustrating the wavelength dependency of the refractive indexes of polydimethylsiloxane (PDMS; exemplarity referred to as “silicone resin portion” recited in the claims), silicon dioxide (SiO₂), and calcium fluoride (CaF₂), respectively. The SiO₂ curve and CaF₂ curve both have intersection points with the PDMS curve, respectively. The wavelength having the intersection point is the above described wavelength λ1. For this reason, by dispersing particles of SiO₂ or CaF₂ in the PDMS, the optical member 1 is expected to be an optical element alternative to the notch filter, which selectively transmits light having the wavelength λ1.

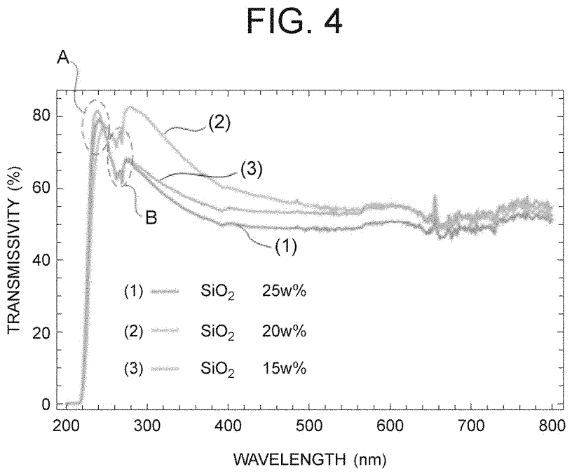

FIG. 4 illustrates the transmissivity property of an optical member (exemplarily referred to as “optical member” recited in the claims) which is obtained by dispersing SiO₂ particles (exemplarily referred to as “optical material particles” recited in the claims) in the PDMS. The vertical axis denotes the transmissivity and the horizontal axis denotes the wavelength of transmitted light.

Here, the SiO₂ particle has a particle size (short diameter or minor axis) of 100 nm, and the SiO₂ particles dispersed in the PDMS has the density of 15, 20, and 25 wt %, respectively. Also, the optical member has the optical path length (“d” in FIG. 2) of 1 mm.

In FIG. 4, the peak wavelength in which the transmissivity becomes maximum is approximately 280 nm (exemplarily referred to as “first wavelength” recited in the claims). The transmissivity of the light having the wavelength of 280 nm becomes maximum in particular for the SiO₂ particles having the density of 20 wt %.

Although a region A in the vicinity of 240 nm has a second peak of the transmissivity, it is assumed that the second peak occurs due to the fluorescence excited by the light incident to the PDMS. Also, although a region B in the vicinity of 260 nm has variation in the transmissivity, it is assumed that the variation in the transmissivity occurs due to residue substances generated when crosslinking and solidifying the PDMS.

As apparent from the result shown in FIG. 4, the above described optical element has a peak of the transmissivity (light permeability) at the specific wavelength (approximately 280 nm). In other words, it is turned out that the above described optical member has a function that selectively transmits light having the wavelength of 280 nm.

It should be noted that it can be assumed to achieve the similar functionality even when the SiO₂ particle has the short diameter equal to or greater than 0.1 μm and equal to or less than 20 μm, the SiO₂ particles in the PDMS has the density equal to or greater than 10 wt % and equal to or less than 20 wt %, and the optical member has the light path length equal to or greater than 0.2 mm and equal to or less than 10 mm.

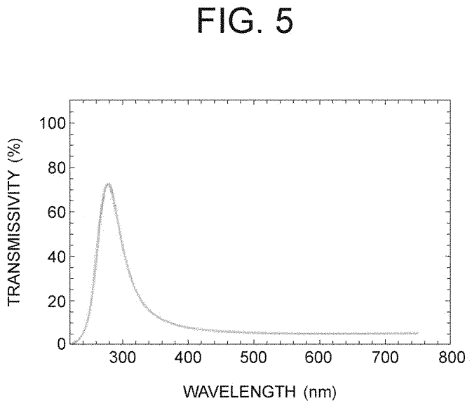

FIG. 5 illustrates the transmissivity property of an optical member (exemplarily referred to as “optical member” recited in the claims) which is obtained by dispersing CaF₂ particles (exemplarily referred to as “optical material particles” recited in the claims) in the PDMS. The vertical axis denotes the transmissivity and the horizontal axis denotes the wavelength of transmitted light.

Here, the CaF₂ particle has a particle size (short diameter or minor axis) equal to or greater than 20 μm and equal to or less than 500 μm, the CaF₂ particles dispersed in the PDMS has the density of 30 wt %. Also, the optical member has the optical path length (“d” in FIG. 2) of 1 mm.

As shown in FIG. 5, the light having the peak wavelength of 280 nm (exemplarily referred to as “first wavelength” recited in the claims), in which the transmissivity becomes maximum, has the transmissivity of approximately 80%, which is particularly high. In other words, it is turned out that the above described optical member has a function that selectively transmits light having the wavelength of 280 nm.

It should be noted that it can be assumed to achieve the similar functionality even when the CaF₂ particle has the short diameter equal to or greater than 20 μm and equal to or less than 500 μm, the CaF₂ particles in the PDMS has the density equal to or greater than 5 wt % and equal to or less than 50 wt %, and the optical member has the light path length equal to or greater than 0.2 mm and equal to or less than 10 mm. It is further preferable if the CaF₂ particles in the PDMS has the density equal to or greater than 10 wt % and equal to or less than 30 wt %.

It should be noted that the peak wavelengths anticipated from FIG. 3 (that is, the wavelength having an intersection point between the SiO₂ curve and the PDMS curve and the wavelength having another intersection point between the CaF₂ curve and the PDMS curve) are deviated from the peak wavelengths in FIGS. 4 and 5, respectively. In FIG. 3, the peak wavelength is calculated by the extrapolation with taking prior art references into consideration, while FIGS. 4 and 5 show the actual measurement results, respectively.

It is assumed that the peak wavelengths in FIG. 3 are deviated from the peak wavelengths in FIGS. 4 and 5, because the increase in the refractive index in the ultra violet region affects due to an additive agent (solidifying agent) used for solidifying in an actual product of the PDMS.

Furthermore, it is possible to change the peak wavelength in which the transmissivity becomes maximum within the range between 250 nm and 300 nm by selecting a PDMS product having a different components of the solidifying agent as appropriate. Although FIG. 5 illustrates that the optical member obtained by dispersing CaF₂ particles in the PDMS selectively transmits light having the wavelength of 280 nm, it has been turned out to be possible to selectively transmit light having the wavelength of 260 nm as well by using a different solidifying agent. It has been also turned out to be possible to selectively transmit light having the wavelength of 250 nm as well if the PDMS is solidified using not the solidifying agent but electron beams.

In addition, it is anticipated that an optical member having a higher wavelength selectivity (selection property) can be obtained by setting the light path length d, the particle diameter of the particles to be dispersed in the silicone resin and the density thereof as appropriate.

Furthermore, when using the optical member according to the present invention for a light measuring device (exemplarily referred to as “light measuring device” recited in the claims), the optical member may be used for a filtering light guiding path (exemplarily referred to as “filtering light guiding path” recited in the claims) by providing the optical member at a part of the light guiding path. Yet furthermore, a pigment-containing resin portion (exemplarily referred to as “pigment resin portion” recited in the claims) may be provided in the circumference of the filtering light guiding path.

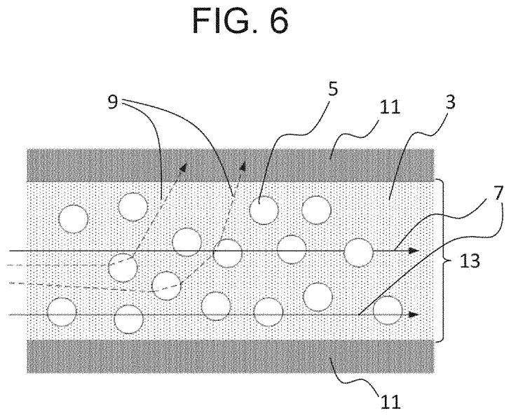

FIG. 6 is a schematic view illustrating a filtering light guiding path 13 in which a pigment-containing resin portion 11 is provided in the circumference thereof. In the pigment-containing resin portion 11, a pigment (colorant) having a property of absorbing light is dispersed in a resin such as PDMS. With the pigment-containing resin portion 11 being provided, light 9 having the wavelength λ2, which is interrupted (barred) from traveling straight in the filtering light guiding path 13 and incident to the pigment-containing resin portion 11, hardly returns back to the filtering light guiding path 13, as the light 9 having the wavelength λ2 is absorbed by the pigment. Further, the light 9 having the wavelength of λ2 hardly leaks outside as stray light from the pigment-containing resin portion 11 so that the stray light is prevented from occurring.

### Embodiment 2

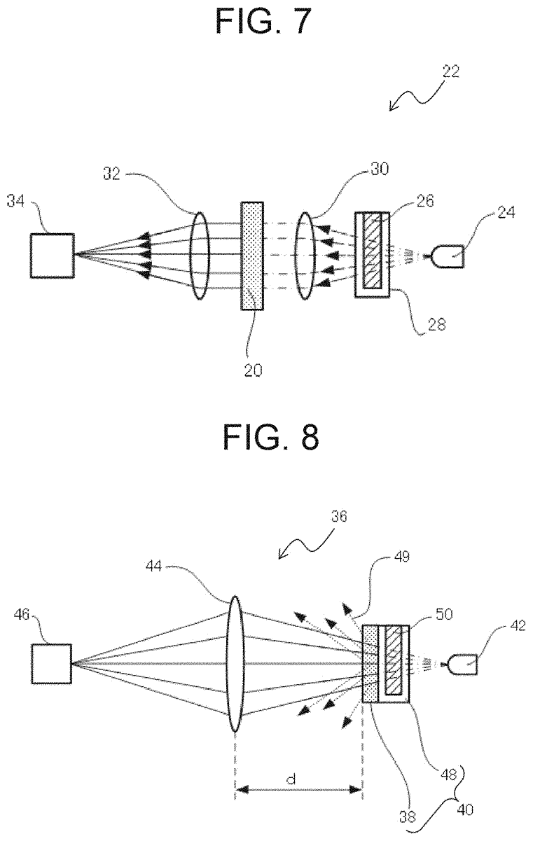

FIG. 7 illustrates a basic configuration of a light measurement (measuring) system 22 provided with an optical member 20 according to the present invention. The light measurement system 22 according to the present invention comprises: a UV light source 24, a UV transmissive cell 28, a first lens 30, an optical member 20, a light condensing optical system, and a sensor 34. The UV light source 24 emits light containing ultra violet light and made of, for example, a UV-Light Emitting Diode (LED). The UV transmissive cell 28 holds a measurement sample 26 (exemplarily referred to as “sample holding member” recited in the claims). The first lens 30 collimates light transmitted through the UV transmissive cell 28 into parallel (collimated) light. The optical 20 member selects predetermined ultra violet light (for example, the wavelength of 260 nm, or 280 nm) from light emitted from the sample 26 irradiated with light containing the ultra violet light. The light condensing optical system includes, for example, a second lens 32 for condensing light selected by the optical member 20. The sensor 34 receives light condensed by the light condensing optical system and performs light measurement.

The UV measurement cell for the light measurement using the ultra violet light is made of, for example, quartz glass having a higher ultra violet transmissivity. However, the UV measurement cell made of the quartz glass is relatively expensive and vulnerable to shocks. For this reason, it has lower handling ability (handleability) during on site measurement as a sample case to be used for the light measuring device for the POCT.

Accordingly, the UV measurement cell 28 to be used for the light measurement system 22 according to the present embodiment is configured using a general purpose silicone resin (elastomer) having a ultra violet transmissivity property instead of the quartz glass. Thus, the UV measurement cell 28 has a higher degree of freedom in manufacturing and facilitates forming into a desired shape. Also, the UV measurement cell 28 has a higher shock resistance as having an elastic property. For this reason, the UV measurement cell 28 has higher handling ability during on site measurement in the POCT as compared to the quartz glass. In addition, it is possible to reduce the manufacturing cost by way of mass production.

Yet furthermore, the light measurement system 22 shown in FIG. 7 can be downsized except for the first lens 30. Conventionally, when using the notch filter for wavelength selectivity function, a certain optical element such as the first lens 30 was required in order to allow an angle of incidence of light into the notch filter to be zero.

On the other hand, the optical member 20 according to the present invention is capable of allowing light having the wavelength in which the refractive indexes of the PDMS and the optical material particles coincide with each other to travel straight, while scattering other light, even when the incidence angle of the light is not zero. Accordingly, as shown in a following Embodiment 3, the light measurement system 22 is capable of performing the light measurement without the first lens 30.

It should be noted that, the above described basic configuration employs a system in which a liquid sample is held in the UV transmissive cell. Thus, it is possible to prepare the measurement sample in advance before performing the measurement. In other words, it is possible to prepare the UV transmissive cell for light measurement into which the liquid sample has been poured, and to prepare a plurality of UV transmissive cells as necessary.

The Patent Literature 3 discloses a method and a device, without employing the UV transmissive cell, which holds a measurement sample (liquid) in the order of microliter in volume in a cylindrical shape using the surface tension and optically measures the held sample. Using this kind of device, it is possible to perform the light measurement using the ultra violet light without the sample being held in the sample case.

However, the measurement sample in the order of microliter is likely to evaporate, and it continuously changes a light path of passing-through light, which passes through the sample during the light measurement so that it makes the stable light measurement extremely difficult.

Furthermore, when performing a plurality of measurements using the above mentioned device, the measurement sample has to be cleaned off (rub away) every time at the measuring portion after the completion of each measurement. For this reason, subsequent measurement may be affected by the previous measurement depending on the extent of cleaning off. For example, once the residual measurement sample of previous measurement slightly remains, it may function as an impurity in the subsequent measurement.

On the other hand, the basic configuration according to the present embodiment employs a system in which the measurement sample is poured into the UV transmissive cell. Thus, the evaporation of the measurement sample hardly affects even with a small amount of liquid sample. Thus, it is possible to perform a stable light measurement.

Yet furthermore, when performing a plurality of measurements, it is sufficient to prepare a plurality of UV transmissive cells each containing measurement sample already poured therein. Thus, it is possible to eliminate cleaning off the measuring portion after every measurement. As a result, the previous measurement hardly affects each of the light measurement so that the light measurement with higher reliability can be performed.

### Embodiment 3

FIG. 8 is a view illustrating a light measurement system 36 (exemplarily referred to as “light measurement system” recited in the claims) provided with a UV transmissive cell 40 including an optical member 38 (exemplarily referred to as “optical member” recited in the claims). The light measurement system 36 according to the present embodiment comprises: a UV light source 42, a light condensing lens 44; and a sensor 46. The UV light source 42 is exemplarily referred to as “light source portion” recited in the claims. The light condensing lens 44 condenses light transmitted through the UV transmissive cell 40 (exemplarily referred to as “light condensing lens portion” recited in the claims). The sensor 46 receives light condensed by the light condensing lens 44 and measures the condensed light (exemplarily referred to as “light measuring portion” recited in the claims.

The UV transmissive cell 40 is configured such that the cell portion 48 is integrated into the optical member 38. The cell portion 48 is made of the silicone resin having a higher ultra violet transmissivity and includes a hollow (cavity) for accommodating the sample 50. The optical member 38 is a part of light transmissive portion in the UV transmissive cell 40 (exemplarily referred to as “light transmissive portion” recited in the claims) through which light is transmitted from the UV light source 42. The optical member 38 is, similarly to the optical member according to the embodiment 1, made of a silicone resin (exemplarily referred to as “silicone resin portion” recited in the claims) in which the optical material particles (exemplarily referred to as “optical material particles” recited in the claims) are dispersed. For this reason, the UV transmissive cell 40 has a wavelength selectivity function that allows only light having the wavelength in which the refractive indexes of the silicone resin and the optical material particles coincide with each other to transmit while scattering other light.

Although both of the notch filter and the optical member 38 similarly have the wavelength selectivity function, the notch filter differs from the optical member 38 in whether the incidence angle of the incident light is required to be zero or not. When using the notch filter, a lens needs to be provided between the notch filter and the sample holding portion in order to allow the incidence angle of light to the notch filter from the sample to be zero. On the other hand, no lens needs to be provided between the optical member 38 and the cell portion 48 in order to allow the incidence angle to be zero. Thus, those components (optical member 38 and the cell portion 48) can be substantially integrally arranged so that downsizing of the light measurement system 36 can be attained.

Furthermore, when the silicone resin is elastomer, the UV transmissive cell 40 has a higher resistance to shocks as having the elastic property. Accordingly, it is possible to facilitate handling during on site measurement in the POCT. Furthermore, it is possible to reduce the manufacturing cost by way of mass production.

When assuming λ1 (exemplarily referred to as “first wavelength” recited in the claims) to be the wavelength in which the refractive indexes of the silicone resin and the optical material coincide with each other, most of light 49 having the wavelength other than the wavelength λ1 (exemplarily referred to as “second wavelength” recited in the claims), out of light transmitted through the optical member 38, scatters in every direction by the optical member 38. On the other hand, light having the wavelength λ1 travels straight while maintaining the property of light emitted from the UV light source, as the light having the wavelength λ1 does not scatter in the optical member 38.

For this reason, by setting the distance between the optical member 38 and the light condensing lens 44 to be a predetermined distance d, a lower light component other than the wavelength λ1 arrives at the light condensing lens 44, thus it is possible to reduce the light incidence amount of light having the wavelength other than the wavelength λ1 into the light condensing lens 44. Then, the light condensing lens 44 selectively condenses, on a light receiving face of the sensor 46, light having the wavelength λ1 transmitted through the light condensing lens 44.

### Embodiment 4

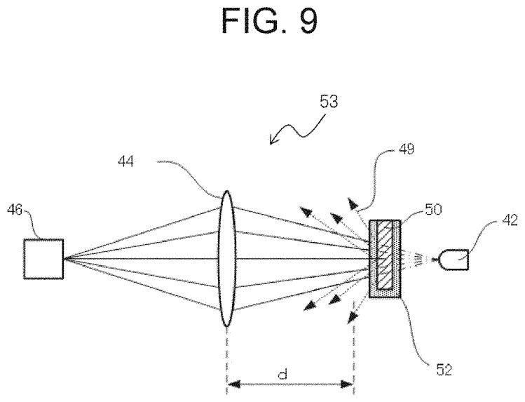

FIG. 9 is a view illustrating a light measurement system 53 provided with a UV transmissive cell 52 composed of the optical member. The above described Embodiment 3 has a structure in which the UV transmissive cell and the optical member are substantially integrally arranged. According to the present embodiment, the optical material particles are dispersed in the UV transmissive cell itself made of the silicone resin so as to add the wavelength selectivity function to the UV transmissive cell 52 itself. As the UV transmissive cell 52 itself functions similarly to the optical member according to the embodiment 3, it is possible to further downsize the light measurement system 53 according to the present embodiment as compared to the light measurement system 36 according to the embodiment 3.

### Embodiment 5

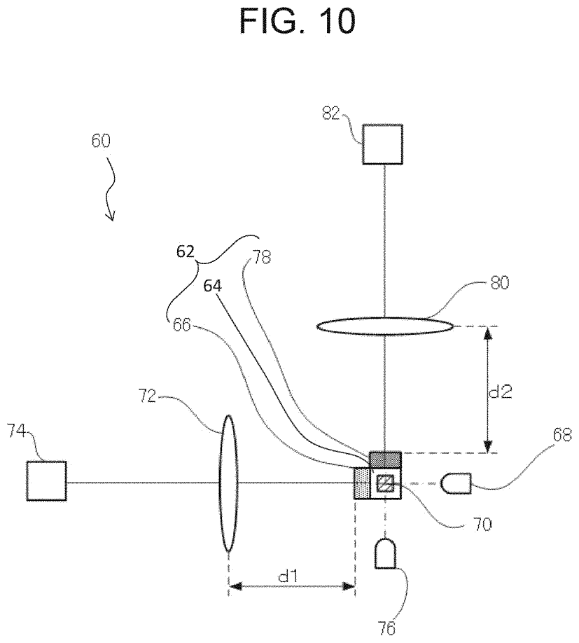

FIG. 10 is a view illustrating a light measurement system 60 provided with a UV transmissive cell 62 including two kinds of optical members and capable of simultaneous light measurement of two wavelengths. The UV transmissive cell 62 according to the present embodiment, similarly to the UV transmissive cell 40 according to the embodiment 3, includes a first particle-containing resin portion 66 (wavelength=λ1: straight traveling; wavelength≠λ1: scattering; exemplarily referred to as “first particle containing resin portion” recited in the claims). The first particle-containing resin portion 66 allows the light having the wavelength λ1 (exemplarily referred to as “first wavelength” recited in the claims) to travel straight at a light transmission side of the cell portion 64 of the UV transmissive cell 62, while scattering light having the wavelength other than λ1 (exemplarily referred to as “second wavelength” recited in the claims). Also, the cell portion 64 is made of silicone resin having a higher ultra violet transmissivity and includes a hollow for accommodating a sample 70.

For this reason, light containing the ultra violet light (wavelength λ1) emitted from a first UV light source 68 (exemplarily referred to as “first light source portion” recited in the claims) is irradiated onto the sample 70 through the cell portion 64 of the UV transmissive cell 62, and light emitted from the sample 70 arrives at the first particle containing resin portion 66 through the cell portion 64. In the first particle containing resin portion 66, the light having the wavelength λ1 passes through without being refracted while maintaining the incidence angle thereof, and the light having the wavelength other than λ1 scatters in every direction.

The light having the wavelength λ1 passes through a first light condensing lens 72 (exemplarily referred to as “first light condensing lens portion” recited in the claims) arranged at a position with a distance d1 from the first particle containing resin portion 66. The light having the wavelength Δ1 is then condensed on a light receiving face of a first sensor 74 (exemplarily referred to as “first light measuring portion” recited in the claims) and measured by the first sensor 74.

Yet furthermore, in the light measurement system 60, a light axis of an optical system, which comprises a second UV light source 76 (exemplarily referred to as “second light source portion” recited in the claims), a second particle containing resin portion 78, a second light condensing lens 80 (exemplarily referred to as “second light condensing lens portion” recited in the claims), and a second sensor 82 (exemplarily referred to as “second light measuring portion” recited in the claims), is set such that the light axis of the optical system has an approximately right angle with respect to a light axis of another optical system, which comprises a first UV light source 68, a first particle containing resin portion 66, a first light condensing lens 72, and a first sensor 74.

In other words, the UV transmissive cell 62 having a quadrangular cross-section has, for example, a quadrangular prism shape. A second particle containing resin portion 78 (exemplarily referred to as “second particle containing resin portion” recited in the claims) is provided on a face intersecting at right angle with a face on which a first particle containing resin 68 is provided. The second particle containing resin portion 78 is made of the silicone resin in which optical material particles different from the first particle containing resin portion 66, and has a wavelength selectivity function that allows light having the wavelength Δ3 (exemplarily referred to as “third wavelength” recited in the claims) different from the wavelength λ1 to travel straight and scatters light having the wavelength other than the wavelength λ3 (exemplarily referred to as “fourth wavelength” recited in the claims).

The light containing ultra violet light (wavelength λ3) emitted from the second UV light source 76 is irradiated onto the sample 70 through the cell portion 64 of the UV transmissive cell 62, and light emitted from the sample 70 arrives at the second particle containing resin portion 78 through the cell portion 64. In the second particle containing resin portion 78, the light having the wavelength λ3 passes through without being refracted while maintaining the incidence angle thereof, and light having the wavelength other than the wavelength λ3 scatters in every direction.

The light having the wavelength λ3 passes through a second light condensing lens 80 arranged at a position with a distance d2 from the second particle containing resin portion 78. The light having the wavelength λ3 is then condensed on a light receiving face of a second sensor 82 and measured by the second sensor 82.

In other words, according to the light measurement system 60 shown in FIG. 10 and a light measurement system having the UV transmissive cell 62, it makes it possible to select two wavelengths (λ1 and λ3) out of light emitted from the sample 70 and also simultaneously measure the two wavelengths.

### Embodiment 6

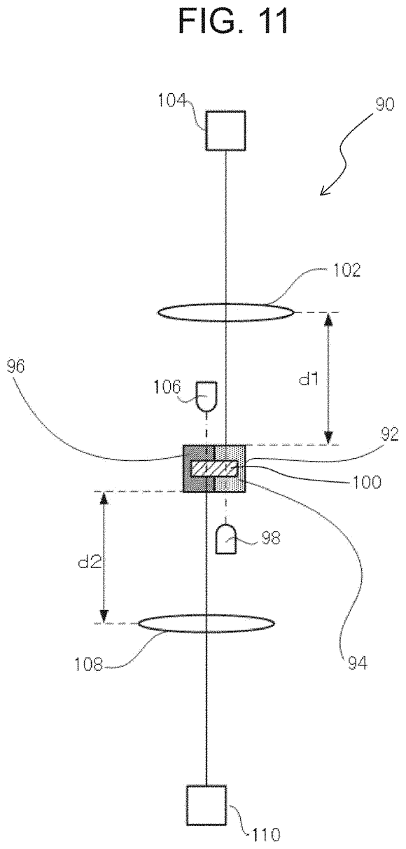

FIG. 11 is a view illustrating a light measurement system 90 provided with a UV transmissive cell 92 made of two kinds of optical members and capable of simultaneous measurement of two wavelengths. Similarly to the embodiment 5, the light measurement system 90 according to the present embodiment selects two wavelengths (λ1 and λ3) out of light emitted from the sample and also simultaneously measures the selected two wavelengths. Also, in the UV transmissive cell 92 according to the present embodiment, similarly to the embodiment 4, the optical material particles are dispersed in the UV transmissive cell itself made of the silicone resin, and thus the wavelength selectivity function is added to the UV measurement cell itself.

The UV transmissive cell 92 is made of two kinds of optical members. One of the optical members is a first particle containing resin portion 94 in which first optical material particles are dispersed in the silicone resin, and the other of the optical members is a second particle containing resin portion 96 in which second optical material particles different from the first optical material particles are dispersed in the silicone resin. The refractive index of the first optical material particles 94 coincides with the refractive index of the silicone resin at the wavelength λ1. Similarly, the refractive index of the second optical material particles 96 coincides with the refractive index of the silicone resin at the wavelength λ3 different from the wavelength λ1.

In other words, the light containing ultra violet light (wavelength λ1) emitted from the first UV light source 98 is irradiated onto the sample 100 through the first particle containing resin portion 94 of the UV transmissive cell 92, and light emitted from the sample 100 passes through the first particle containing resin portion 94 of the UV transmissive cell 92. In the first particle containing resin portion 94, the ultra violet light (wavelength λ1) passes therethrough without being refracted while maintaining the incidence angle thereof, while light having the wavelength other than the wavelength λ1 scatters in every direction. The light having the wavelength λ1 passes through a first light condensing lens 102 arranged at a position with a distance d1 from the first particle containing resin portion 94 in order to reduce the amount of arriving light having the wavelength other than λ1 to be sufficiently small. The light having the wavelength λ1 is then condensed on a light receiving face of a first sensor 104 and measured by the first sensor 104.

Similarly, the light containing ultra violet light (wavelength λ3) emitted from the second UV light source 106 is irradiated onto the sample 100 through the second particle containing resin portion 96 of the UV transmissive cell 92, and light emitted from the sample 100 passes through the second particle containing resin portion 96 of the UV transmissive cell 92. In the second particle containing resin portion 96, the ultra violet light (wavelength λ3) passes therethrough without being refracted while maintaining the incidence angle thereof, while light having the wavelength other than the wavelength λ3 scatters in every direction. The light having the wavelength λ3 passes through a second light condensing lens 108 arranged at a position with a distance d2 from the second particle containing resin portion 96 in order to reduce the amount of arriving light having the wavelength other than λ3 to be sufficiently small. The light having the wavelength λ3 is then condensed on a light receiving face of a second sensor 110 and measured by the second sensor 110.

In other words, according to the light measurement system 90 shown in FIG. 11, it makes it makes it possible to select two wavelengths (λ1 and λ3) out of light emitted from the sample 70 and also simultaneously measure the two wavelengths.

It should be noted that, although the light measurement system 90 according to the present embodiment is configured with identical and the same number of components to the light measurement system 60 according to the embodiment 5, the light measurement system 90 differs from the light measurement system 60 in arrangement thereof. By arranging respective components according to the present embodiment, it makes it possible to easily reduce light incident to the first sensor 104 from the second UV light source 106 and also light incident to the second sensor 110 from the first UV light source 98.

### Embodiment 7

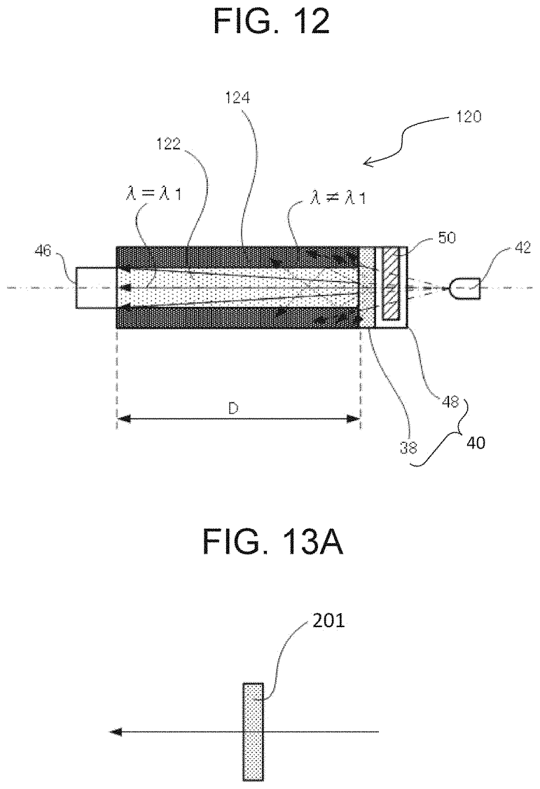

FIG. 12 is a view illustrating a light measurement system 120 in which a Silicone Optical Technologies (SOT) is applied to the light measurement system 36 according to the embodiment 3. SOT is an invention that is invented by the inventors of the present invention. SOT is a technology to attain an improvement in the resistance to the vibration and shocks in the light measuring device and suppression of the stray light and scattering light by configuring the optical system with the transparent silicone resin and the pigment-containing resin (see, for example, Patent Literatures 1 and 2).

A UV transmissive cell 40 according to the present embodiment is configured, similarly to the embodiment 3, such that a cell portion 48 and an optical member 38 are integrally arranged or formed.

The light measurement system 120 includes, similarly to the embodiment 3, a UV light source 42 and a sensor 46. In addition, the light measurement system 120 is provided with, between the optical member 38 and the sensor 46, a light guiding path portion 122 which is filled with the transparent silicone resin, such as the PDMS or the like, with respect to the ultra violet light. Also, the light guiding path portion 122 is surrounded or enclosed by, except for faces contacting the optical member 38 and the sensor 46, a pigment-containing resin portion 124 which contains the pigment having a property to absorb the stray light.

With the light measurement system being so configured, light other than incident light to the light guiding path portion 122, out of light emitted from the optical member 38, enters into the pigment-containing resin portion 124 and absorbed therein. For this reason, the incident amount of light emitted from the optical member 38 to the light guiding path portion 122 is restricted with a cross-sectional area of the light guiding path portion 122.

Also, in particular, the light having the wavelength other than the wavelength λ1 emitted from the optical member 38 is mostly the scattering light so that such light is incident to the pigment-containing resin portion 124 from the light guiding path portion 122 and then absorbed therein during traveling through the light guiding path portion 122.

For this reason, by setting the cross-sectional area and the length D of the light guiding path portion 122 as appropriate, the light having the wavelength other than the wavelength λ1 is mostly absorbed by the pigment-containing resin portion 124 and hardly arrives at the sensor 46. On the other hand, the light that has not entered into the pigment-containing resin portion 124, out of light having the wavelength λ1, entirely arrives at the sensor 46. As the light having the wavelength λ1 is not scattered by the optical member 38, the amount of light absorbed by the pigment-containing resin portion 124 is extremely small as compared to light having the wavelength other than wavelength λ1. As a result, it is possible to sense light by the sensor 46 without providing the light condensing lens or the like.

As the light condensing lens can be omitted, it makes it possible to further downsize the light measurement system 120 according to the present embodiment as compared to the light measurement system 36 according to the embodiment 3.

It should be noted that, although the embodiments 5 and 6 have illustrated examples of two kinds of optical members having different wavelength properties in which different kinds of optical material particles are dispersed in the same silicone resin, respectively, the kind of the silicone resin may be changed instead of the optical material particles.

For example, a first particle containing resin portion may be configured by dispersing CaF₂ in a first silicone resin (product name “SIM-360”, manufactured by Sin-Etsu Chemical Co., Ltd.; exemplarily referred to as “first silicone resin portion” recited in the claims), and a second particle containing resin portion may be configured by dispersing CaF₂ in a second silicone resin (product name “KE-103”, manufactured by Sin-Etsu Chemical Co., Ltd.; exemplarily referred to as “second silicone resin portion” recited in the claims) different from the first silicone resin.

### Embodiment 8

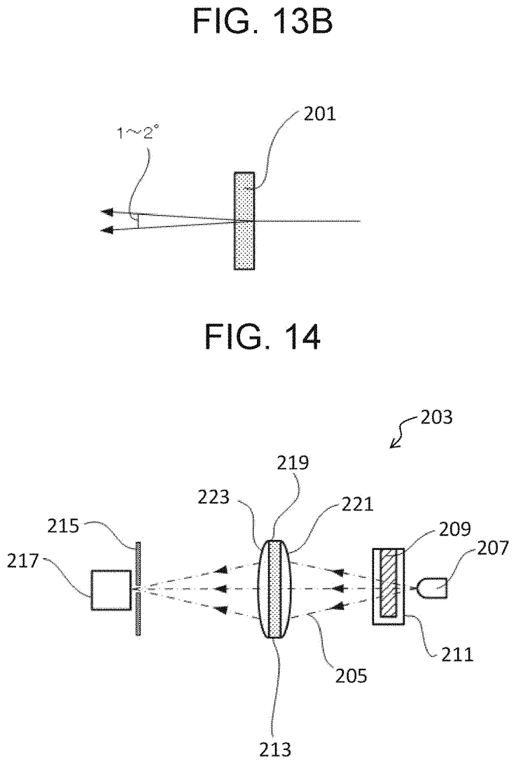

FIG. 13 is a view illustrating a light axis by an arrow when an optical member 201 according to the present invention, which selectively transmits light having the wavelength of 260 nm is irradiated with (a) light having the wavelength of 260 nm, and (b) light having the wavelength of 280 nm. The optical member 201 has been fabricated by employing, as the silicone resin, PDMS with the product name of “SIM-360” manufactured by Shin-Etsu Chemical Co., Ltd., and employing CaF₂ as the optical material particles.

As shown in FIG. 13, while the ultra violet light having the wavelength of 260 nm travels straight in the optical member 201, the ultra violet light having the wavelength of 280 nm is scattered by CaF₂ in the silicone resin, and then emitted from the optical member 201 as diffused light having a diffusion angle φ of 1 to 2 degrees.

For this reason, when dispersing light having the wavelength of 260 nm and light having the wavelength of 280 nm, the light path length is required to be approximately 10 to 30 cm. When assuming that a diameter of light incident to the optical member 201 is d (cm), a spread angle that the incident light originally has is ±θ (degrees), a light receiving range (diameter) of the sensor receiving light transmitted through the optical member 201 is also d (cm), the intensity ratio of light arriving at the sensor having the wavelength of 260 nm to light arriving at the sensor having the wavelength of 280 nm can be expressed in the following Expression (1). Here, φ denotes scattering (diffusion) angle (degrees) by the optical material particles (for example, CaF₂ particles) in the optical member 201.

When light incident to the optical member 201 has the diameter of 1 mm, and such light originally has the spread angle of approximately ±1 degree, in case of the light guiding path length being 10 to 30 cm, the intensity ratio becomes 3.1 to 3.7 times where φ is 1 degree. However, the light intensity (brightness of light) of the measurement light arriving at the sensor is in inverse proportion to a square of distance. Then, even when the light receiving face (diameter) of the sensor is 1 cm, a part of light arriving at the sensor goes out of the sensor. As a result, the measurement light received by the sensor becomes dark.

$$\begin{matrix}[ Expression 1 ] & \\ \frac{{I}_{{λ}_{260}}}{{I}_{{λ}_{280}}} = {\{ \frac{90 d + L π ( θ + φ )}{90 d + L π θ} \}}^{2} & ( 1 )\end{matrix}$$

Taking the above observation into consideration, in order to achieve further downsizing of the light measuring device and suppression of measurement signals from attenuating, the light measuring device 203 according to the present embodiment is configured as shown in FIG. 14. The light measuring device 203 according to the present embodiment includes a light source 207 for emitting ultra violet light 205, a UV measurement cell 211 for accommodating a liquid sample 209, a wavelength selection filter unit 213, an aperture member 215, and a sensor 217.

The light source 207 is made of, for example, a small sized UV-LED (Light Emitting Diode). The UV measurement cell 211 is configured using, for example, a general purpose silicone resin (elastomer) having the ultra violet transmissivity property. The sensor 217 receives light, which is emitted from the liquid sample and then wavelength-selected by the wavelength selection filter unit 213, and measures the property of the light.

### Wavelength Selection Filter Unit

The wavelength selection filter unit 213 is a lens unit configured by interposing a plate-like optical member 219 between a plano-convex lens 221 at the light incident side and a plano-convex lens 223 at the light exit side. The optical member 219 is made of, similarly to the optical member according to the embodiment 1, a silicone resin (exemplarily referred to as “silicone resin portion” recited in the claims) in which the optical material particles (exemplarily referred to as “optical material particles” recited in the claims) is dispersed therein.

For this reason, the wavelength selection filter unit 213 has the wavelength selectivity function that allows only light having the wavelength, at which the refractive indexes of the silicone resin and the optical material particles coincide with each other, to travel straight and scatters other light.

According to the present embodiment, the wavelength selection filter unit 203 is configured by interposing the plate-like optical member 219 between the plano-convex lens 221 at the light incident side and the plano-convex lens 223 at the light exit side. Also, the light source 207, the wavelength selection filter unit 203, the aperture member 215, and the sensor 217 are arranged such that the light emitted from the light source 207 passes through the wavelength selection filter unit 213, is condensed at the aperture member 215, and then arrives at the sensor 217.

Thus, it makes it possible to achieve a structure in which only desired light having a specific wavelength is condensed and incident to the sensor 217 effectively while light having different wavelength, which has less light-harvesting (condensing) property than the light having the specific wavelength, hardly arrives at the sensor 217.

In the above described expression (1) of the intensity ratio, the spread angle θ that the light source 207 originally has can be assumed to be zero. Thus, even assuming that the diameter of light d is 0.1 cm, the intensity ratios when the light path length from the plano-convex lens 223 to the sensor 217 is 4 cm and 10 cm are 5 times and 20 times, respectively. As a result, it makes it possible to further shorten the light path length. In addition, as the spread angle θ is negligible, it makes it possible to suppress the light intensity on the light receiving face of the sensor from attenuating.

It should be noted that the light measurement system may include either the plano-convex lens 221 at the light incident side or the plano-convex lens 223 at the light exit side, when the light intensity of the measurement light is sufficient.

Also, preferably, the thickness of the optical member 219 is larger than the mean free process inside the optical member 219. Also, the upper limit of the thickness is preferably determined in consideration of the transmissivity. For example, when the ratio by weight of the silicone resin to CaF₂ is 7:3 and CaF₂ has the average particle diameter of 1 μm, then the thickness of the optical member 219 may be within the range between 50 μm to 5 mm.

It should be noted that an aperture member 215 having an opening may be provided at the light incident side of the sensor 217 in order to configure a spatial filter on the light path between the wavelength selection filter unit 213 and the sensor 217.

### Embodiment 9

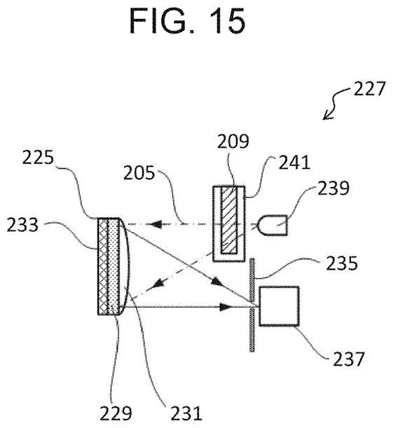

FIG. 15 is a view illustrating a light measuring device 227 including a wavelength selection filter unit 225 different from the eighth embodiment. The wavelength selection filter unit 225 of the light measuring device 227 includes an optical member 229, a plano-convex lens 231, and a reflective mirror 233, all of which are integrally arranged or formed. More particularly, the plano-convex lens 231 is arranged at the light incident side of the plate-like optical member 229, and the reflective mirror 233 is arranged at the opposite side of the plano-convex lens 231 with the optical member 229 being interposed therebetween.

In the wavelength selection filter unit 225, light incident to the lens arranged at the light incident side passes through the optical member 229, is wavelength-selected, and then folded back by the reflective mirror 233. The folded light again passes through the optical member 229, is wavelength-selected, and then exits from the plano-convex lens 231.

By folding the light path once, the aperture member 235 and the sensor 237 are arranged not at the opposite side but at the same side to the light source 239 and the UV measurement cell 241 with respect to the wavelength selection filter unit 225. For this reason, it makes it possible to further downsize the light measuring device 227 as compared to the light measuring device 203 shown in FIG. 6.

In addition, as light passes through the optical member 229 twice, it makes it possible to obtain the equivalent wavelength selectivity property with a half thickness of the optical member 219 according to the embodiment 8.

### REFERENCE SIGNS LIST

1: Optical Member
3: Silicone Resin
5: Particles
7: Light having Wavelength λ1
9: Light having Wavelength λ2
11: Pigment-Containing Resin Member
13: Filtering Light Guiding Path
20: Optical Member
22: Light Measurement System
24: UV Light Source
26: Measurement Sample
28: UV Transmissive Cell
30: First Lens
32: Second Lens
34: Sensor
36: Light Measurement System
38: Optical Member
40: UV Transmissive Cell
42: UV Light Source
44: Light Condensing Lens
46: Sensor
48: Cell Portion
49: Light having Wavelength other than λ1
50: Sample
52: UV Transmissive Cell
53: Light Measurement System
60: Light Measurement System
62: UV Transmissive Cell
64: Cell Portion
66: First Particle Containing Resin Portion
68: First UV Light Source
70: Sample
72: First Light Condensing Lens
74: First Sensor
76: Second UV Light Source
78: Second Particle Containing Resin Portion
80: Second Light Condensing Lens
82: Second Sensor
90: Light Measurement System
92: UV Transmissive Cell
94: First Particle Containing Resin Portion
96: Second Particle Containing Resin Portion
98: Second Particle Containing Resin Portion
100: Sample
102: First Light Condensing Lens
104: First Sensor
106: Second UV Light Source
108: Second Light Condensing Lens
110: Second Sensor
120: Light Measurement System
122: Light Guiding Path Portion
124: Pigment-Containing Resin Portion
201: Optical Member
203: Light Measuring Device
205: Ultra Violet Light
207: Light Source
209: Liquid Sample
211: UV Measurement Cell
231: Wavelength Selection Filter Unit
215: Aperture Member
217: Sensor
219: Optical Member
221: Plano-convex Lens
223: Plano-convex Lens
225: Wavelength Selection Filter Unit
227: Light Measuring Device
229: Optical Member
231: Plano-convex Lens
233: Reflective Mirror
235: Aperture Member
237: Sensor
239: Light Source
241: UV Measurement Cell

1. An optical member comprising:
a silicone resin portion; and
optical material particles dispersed in the silicone resin portion,
the optical member interrupting straight traveling of light having a second wavelength rather than light having a first wavelength, and
a refractive index of the silicone resin and a refractive index of the optical material particles coinciding with each other at the first wavelength and not coinciding with each other at the second wavelength.

2. The optical member according to claim 1, wherein the silicone resin portion is made of polydimethylsiloxane (PDMS) and the optical material particles are made of silicon dioxide (SiO₂).

3. The optical member according to claim 2, wherein the optical material particles have a short diameter equal to or greater than 0.1 μm and equal to or less than 20 μm,
the optical material particles in the silicone resin portion has a density equal to or greater than 10 wt % and equal to or less than 20 wg %, and
the optical material particles have a light path length equal to or greater than 0.2 mm and equal to or less than 10 mm.

4. The optical member according to claim 1, wherein the silicone resin portion is made of polydimethylsiloxane (PDMS) and the optical material particles are made of calcium fluoride (CaF₂).

5. The optical member according to claim 4, wherein the optical material particles have a short diameter equal to or greater than 20 μm and equal to or less than 500 μm,
the optical material particles in the silicone resin portion has a density equal to or greater than 5 wt % and equal to or less than 50 wg %, and
the optical material particles have a light path length equal to or greater than 0.2 mm and equal to or less than 10 mm.

6. A light measuring device, comprising:
a filtering light guiding path including the optical member according to claim 1 at least as a part of a light guiding path thereof; and
a pigment-containing resin portion that contacts the filtering light guiding path.

7. A sample holding member for holding sample for light measurement, wherein the optical member according to claim 1 is provided at least as a part of a light transmissive portion thereof.

8. The sample holding member according to claim 7, wherein the sample holding member is entirely made of the optical member.

9. The sample holding member according to claim 7, wherein
the optical member includes:
a first particle containing resin portion that has first particles as the optical material particles; and
a second particle containing resin portion that has second particles different from the first particles as the optical material particles,
a refractive index of the silicone resin and a refractive index of the first particles coincide with each other at the first wavelength and do not coincide with each other at the second wavelength different from the first wavelength, and
a refractive index of the silicone resin and a refractive index of the second particles coincide with each other at a third wavelength different from the first wavelength and do not coincide with each other at a fourth wavelength different from the third wavelength.

10. The sample holding member according to claim 7, wherein
the optical member includes:
a first particle containing resin portion that has a first silicone resin portion as the silicone resin portion; and
a second particle containing resin portion that has a second silicone resin portion made of silicone resin different from the first silicone resin portion as the silicone resin portion,
a refractive index of the first silicone resin portion and a refractive index of the optical material particles coincide with each other at the first wavelength and do not coincide with each other at the second wavelength different from the first wavelength, and
a refractive index of the second silicone resin portion and a refractive index of the optical material particles coincide with each other at a third wavelength different from the first wavelength and do not coincide with each other at a fourth wavelength different from the third wavelength.

11. A light measurement system comprising a sample holding member for holding a sample and a light measuring device,
the light measuring device includes:
a light source portion that irradiates the sample with light;
a light condensing lens portion that condenses light from the sample; and
a light measuring portion that measures light condensed by the light condensing lens portion,
the sample holding member being the sample holding member according to claim 7.

12. The light measurement system according to claim 11, wherein
the sample holding member includes:
a first transmissive portion that has a first particle containing resin portion having first particles as the optical material particles; and
a second transmissive portion that has a second particle containing resin portion having second particles different from the first particles as the optical material particles, and
the light measuring device includes:
a first light source portion that irradiates the sample with first light;
a second light source portion that irradiates the sample with second light;
a first light condensing lens portion that condenses light from the sample, the light being transmitted through the first transmissive portion;
a second light condensing lens portion that condenses light from the sample, the light being transmitted through the second transmissive portion;
a first light measuring portion that measures light condensed by the first light condensing lens portion; and
a second light measuring portion that measures light condensed by the second light condensing lens portion.

13. The light measurement system according to claim 12, wherein the first light source portion and the second light source portion are positioned such that the first light source portion and the second light source portion irradiate opposing faces of the sample holding member with light, respectively, and
a part of the sample holding member that transmits the first light includes the first particle containing resin portion, and a part of the sample holding member that transmits the second light includes the second particle containing resin portion.

14. A light measurement system comprising a sample holding member for holding a sample and a light measuring device,
the light measuring device includes:
a light source portion that irradiates the sample with light;
a light measuring portion that measures light from the sample;
a transparent resin portion that fills between a light transmissive portion of the sample holding member and a light receiving face of the light measuring portion; and
a pigment-containing resin portion that encloses the transparent resin portion, and
the sample holding member being the sample holding member according to claim 7.

15. A specific wavelength light condensing member for condensing light having a first wavelength from a sample, comprising:
a lens portion that condenses light from the sample; and
the optical member according to claim 1, and
the optical member is adjacent to the lens portion.

16. The specific wavelength light condensing member according to claim 15, wherein the optical member is provided with plano-convex lenses at least at a light path upstream side and a light path downstream side.

17. The specific wavelength light condensing member according to claim 15, wherein
at least one plano-convex lens is provided as the lens portion,
the specific wavelength light condensing member further comprises a light reflective portion that reflects light, and
both of incident light to the light reflective portion from the sample and reflective light thereof are transmitted through both the plano-convex lens and the optical member.

18. A light measuring device for measuring light having a first wavelength from a sample, comprising:
a light source portion that irradiates the sample with light;
a specific wavelength light condensing member that condenses light having the first wavelength from the sample; and
a light measuring portion that measures light condensed by the specific wavelength light condensing member, and
the specific wavelength light condensing member being the specific wavelength light condensing member according to claim 15.

19. The light measuring device according to claim 18, further comprising an aperture member at a light incident side of the light measuring portion.
